(19) United States
(12) Patent Application Publication
(10) Pub. No.: US 2023/0208144 A1
(43) Pub. Date: Jun. 29, 2023

(54) APPARATUS AND METHOD FOR CONTROLLING TEST CHARGING AND DISCHARGING BASED ON VEHICLE TO GRID TECHNOLOGY

(71) Applicants: Hyundai Motor Company, Seoul (KR); Kia Corporation, Seoul (KR)

(72) Inventors: Kyoung Joo Kim, Daejeon (KR); Jae Yun Jung, Hwaseong (KR); Hye Won Kim, Gwangmyeong (KR)

(21) Appl. No.: 17/868,423

(22) Filed: Jul. 19, 2022

(30) Foreign Application Priority Data
Dec. 27, 2021 (KR) 10-2021-0188062

(51) Int. Cl. H02J 3/32; H02J 7/00; B60L 55/00; B60L 58/12; G06Q 40/00

(52) U.S. Cl. CPC H02J 3/322; H02J 7/00712; H02J 7/0048; H02J 7/0068; H02J 7/007194; B60L 55/00; B60L 58/12; G06Q 40/10; B60L 2240/36

(57) ABSTRACT

Provided are an apparatus and a method for controlling test charging and discharging based on vehicle to grid (V2G) technology. The apparatus comprises a vehicle controller selecting a control command for charging, discharging, or charging/discharging a battery and a charge/discharge controller charging, discharging, or charging/discharging the battery according to the selected control command, wherein an operation of the vehicle controller and an operation of the charge/discharge controller are performed for a standby time in which calculation is performed on a charge profile.

### CROSS-REFERENCE TO RELATED APPLICATION

This application is based on and claims under 35 U.S.C. § 119(a) benefit of priority to Korean Patent Application No. 10-2021-0188062 filed on Dec. 27, 2021 in the Korean Intellectual Property Office, the disclosure of which is incorporated herein by reference in its entirety.

### TECHNICAL FIELD

Embodiments of the present disclosure relate to an apparatus, method, and computer-readable storage medium for controlling test charging and discharging based on vehicle-to-grid (V2G) technology.

### BACKGROUND

Electric vehicles, which have come to prominence as eco-friendly vehicles, have not become widely prevalent yet and thus have not had special problems during charging yet. However, if the supply of electric vehicles increases in the future, the amount of power required to charge electric vehicles may also sharply increase, which may result in large-scale blackouts. In order to solve this problem, V2G technology for differently controlling the charge/discharge amount of electric vehicles according to a situation of a power grid when charging electric vehicles has been introduced.

V2G technology is a service technology that may provide users with a difference in electricity tariffs occurring during charging and discharging as a profit by charging a battery of an electric vehicle by a charger when the electricity tariff is low and discharging power charged in the battery of the electric vehicle to the charger when the electricity tariff is high.

When charging an electric vehicle using the V2G technology, a controller of the electric vehicle performs calculations for a charge profile for performing charging at minimum cost using a target charge amount input by a user, a reserved charging completion time, and tariff information received from the charger (or an external server). A time for which the calculation is performed is called a standby time.

That is, as shown in FIG. 1, calculation is performed on the charge profile for a standby time T12, starting from a time T1 at which a charging cable is connected, and the electric vehicle is charged, starting from a time T2 at which the calculation is completed, according to the charge profile 10.

For the standby time, the electric vehicle and the charger are all in a standby state, so an equipment operation rate is low. In addition, since a charging/discharging operation state of the electric vehicle is not separately displayed, it is not possible to check whether charging is being performed properly, which may cause anxiety and inconvenience for a user.

### RELATED ART DOCUMENT

### Patent Document

(Patent document 1) Korean Patent Registration No. 10-2182321 (“V2G-based charging device and driving method of the device”, registration date: Nov. 18, 2020)

### SUMMARY

An exemplary embodiment of the present disclosure may provide an apparatus, method, and computer-readable storage medium for controlling test charging and discharging based on vehicle to grid (V2G) technology, capable of increasing an equipment operation rate for a standby time, previously checking control safety between a vehicle and a charger and simultaneously resolving user anxiety and inconvenience, and providing a financial gain to a driver.

According to an exemplary embodiment of the present disclosure, an apparatus for controlling test charging and discharging based on vehicle to grid (V2G) technology may include: a vehicle controller selecting a control command for charging, discharging, or charging/discharging a battery; and a charge/discharge controller charging, discharging, or charging/discharging the battery according to the selected control command, wherein an operation of the vehicle controller and an operation of the charge/discharge controller are performed for a standby time in which a calculation is performed on a charge profile.

According to another exemplary embodiment of the present disclosure, a method for controlling test charging and discharging based on vehicle to grid (V2G) may include: a first operation of selecting, by a vehicle controller, a control command for charging, discharging, or charging/discharging a battery; and a second operation of charging, discharging, or charging/discharging the battery, by a charge/discharge controller, according to the selected control command, wherein the first operation and the second operation are performed for a standby time in which calculation is performed on a charge profile.

According to another exemplary embodiment of the present disclosure, a computer-readable storage medium may store a program for executing the above method in a computer.

As discussed, the method and system suitably include use of a controller or processer.

In another embodiment, vehicles are provided that comprise an apparatus as disclosed herein.

### BRIEF DESCRIPTION OF DRAWINGS

The above and other embodiments, features and other advantages of the present disclosure will be more clearly understood from the following detailed description taken in conjunction with the accompanying drawings, in which:

FIG. 1 is a diagram illustrating a standby time during charging based on V2G;

FIG. 2 is a diagram illustrating an apparatus for controlling test charging/discharging based on vehicle-to-grid (V2G) technology according to an exemplary embodiment of the present disclosure;

FIG. 3 is a diagram illustrating a standby time for which a test charging/discharging operation is performed according to an exemplary embodiment of the present disclosure;

FIG. 4A is a diagram illustrating a test charging/discharging operation state for a standby time according to an exemplary embodiment of the present invention;

FIGS. 4B to 4D are diagrams illustrating expected charging/discharge profiles until the end of charging after completion of calculation on a charge profile according to an exemplary embodiment of the present disclosure;

FIG. 5 is a diagram illustrating various profiles of a control command according to an exemplary embodiment of the present disclosure;

FIG. 6 is a flowchart illustrating a method for controlling test charging/discharging based on V2G technology according to an exemplary embodiment of the present disclosure; and

FIG. 7 is a block diagram of a computer device capable of fully or partially implementing an apparatus for controlling test charging/discharging based on the V2G technology according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles. As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described with reference to the accompanying drawings. However, the embodiments of the present disclosure may be modified in various other forms, and the scope of the present disclosure is not limited only to the embodiments described below. The shapes and sizes of elements in the drawings may be exaggerated for clearer description, and elements indicated by the same reference numerals in the drawings are the same elements.

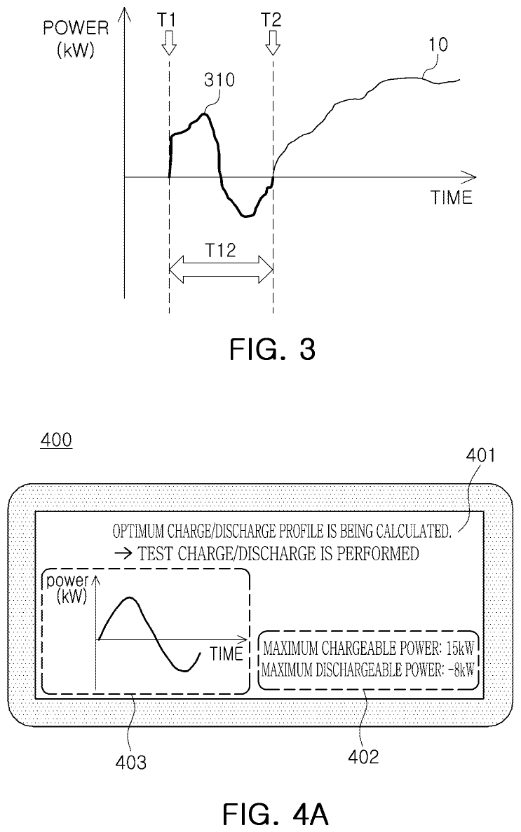

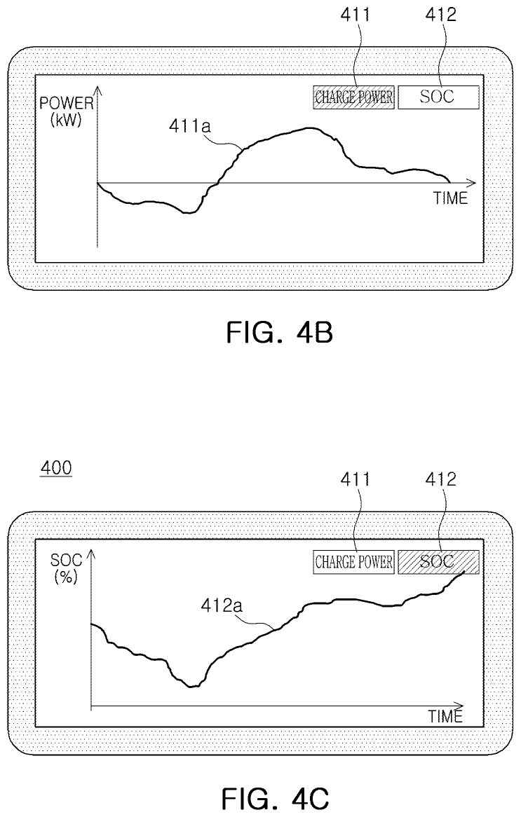

FIG. 2 is a diagram illustrating an apparatus for controlling test charging and discharging based on vehicle-to-grid (V2G) technology according to embodiment of the present inventive concept. Meanwhile, FIG. 3 is a diagram illustrating a standby time during which a test charging/discharging operation is performed according to an exemplary embodiment of the present disclosure.

As shown in FIG. 2, an apparatus 210 for controlling test charging and discharging based on V2G technology may be mounted on, for example, an electric vehicle and may receive power from a charger 220 connected to an intelligent power grid or may provide power.

The apparatus 210 for controlling test charging and discharging based on V2G technology may include a charging terminal 211, a communication unit 212, an input/output unit 213, a battery 214, a charge/discharge controller 215, a battery management unit 216, and a vehicle controller 217.

The charging terminal 211 may be connected to the charger 220 through a charging cable to receive power from the charger 220 or, conversely, to provide power to the charger 220.

The communication unit 212 may receive tariff information from the charger 220. The received tariff information may be transmitted to the vehicle controller 217. The tariff information may include, for example, time-based tariffs, and such tariff information may be changed in real time.

A calculation for a charge profile may be performed according to the tariff information described above, and FIG. 3 shows a standby time T12 for which calculation is performed.

That is, as shown in FIG. 3, calculation is performed on a charge profile 10 for performing charging at minimum cost using a target charge amount received from a user, starting from a time point T1 at which a charging cable is connected, a reserved charge completion time, and tariff information received from the charger (or an external server), and an electric vehicle is charged according to the calculated charge profile 10, starting from a time point T2 at which the calculation is completed.

Therefore, in the present disclosure, the standby time T12 refers to a time duration from the time point T1 at which the charging cable is connected to the time point T2 at which calculation for the charge profile 10 is completed, and according to an exemplary embodiment of the present inventive concept, test charging/discharging may be performed, which will be described below, for the standby time T12. Reference numeral 310 denotes power charged/discharged for the standby time.

Referring back to FIG. 2, the input/output unit 213 may receive a target charge amount, a reserved charge completion time, and the like from the user, and may also display a test charging/discharging operation state for the standby time. The input/output unit 213 described above may be referred to as, for example, audio video navigation (AVN).

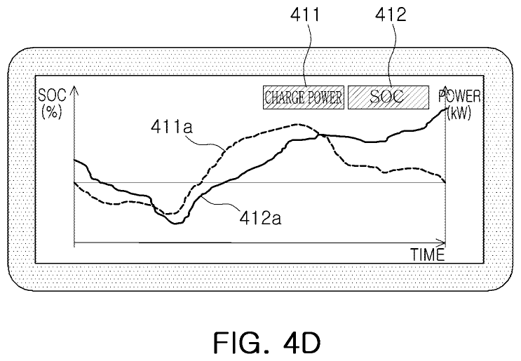

FIG. 4A is a diagram illustrating a test charging/discharging operation state 400 for a standby time displayed in an input/output unit according to an exemplary embodiment of the present disclosure.

As shown in FIG. 4A, the input/output unit 213 may display a phrase 401 such as “optimal charge/discharge profile is calculated. Test charging/discharging is being performed”, may display charge power charged to the battery 214 and discharge power discharged from the battery 214 to the charger 220 in real time during test charging/discharging (403), and display maximum charge power and maximum discharge power charging/discharged during the test charging/discharging (402).

Meanwhile, FIGS. 4B to 4D are diagrams illustrating expected charging/discharge profiles till the completion of calculation for the charging/discharge profile after calculation for the charge profile is completed according to an exemplary embodiment of the present disclosure.

When a charge power button 411 is touched as shown in FIG. 4A, an estimated charge power 411a over time may be displayed, when an SOC button 412 is touched as shown in FIG. 4C, an estimated SOC 412a over time may be displayed, or when both the charge power button 411 and the SOC button 415 are clicked as shown in FIG. 4D, the estimated charge power 411a and the estimated SOC 412a over time may be displayed in one screen. Here, the touched button may be displayed to have a different color to indicate an activated state.

Meanwhile, the battery 214 may be used as a power source for driving a driving motor of an electric vehicle.

The battery management unit 216 may provide a state of the battery, for example, a SOC (SOC) of the battery, and a temperature of the battery to the vehicle controller 217.

In addition, the battery management unit 216 may provide charge power charged to the battery 214 during the test charging/discharging, the discharge power discharged from the battery 214 to the charger 220, a maximum charge power and a maximum discharge power charged and discharged during the test charging/discharging to the input/output unit 213 through the vehicle controller 217. The battery management unit described above may be referred to as a battery management system (BMS).

The vehicle controller 217 may select a control command for charging, discharging, or charging/discharging the battery 214. The selected control command may be provided to the charge/discharge controller 215.

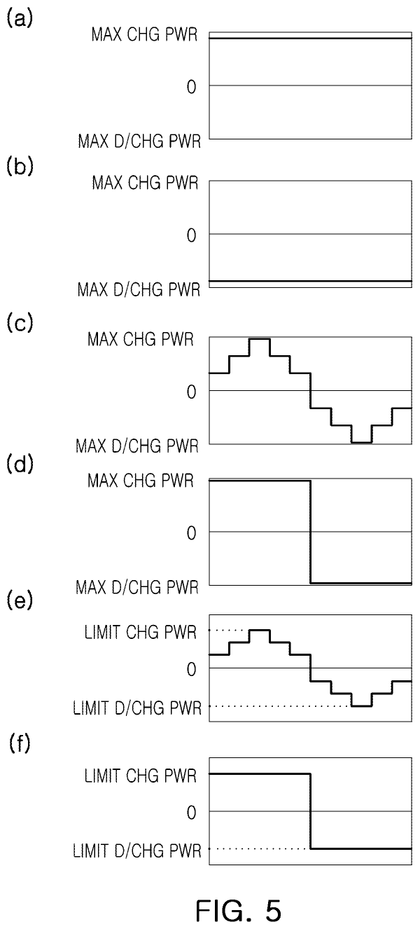

FIG. 5 illustrates various profiles of control commands according to an exemplary embodiment of the present disclosure.

As shown in FIG. 5, control commands may include one of a charge command including a charge profile (refer to (a)) configured to charge the battery with allowable maximum charge power MAX CHG PWR for a standby time, a discharge command including a discharge profile (refer to (b)) configured to discharge the battery with allowable maximum discharge power MAX D/CHG PWR for the standby time, a charge/discharge command including charge/discharge profiles (refer to (c) and (d)) configured to charge and discharge the battery with the allowable maximum charge power MAX CHG PWR and the allowable maximum discharge power MAX D/CHG PWR, as maximum values, for the standby time, and a limited charge/discharge command including limited charge/discharge profiles (refer to (e) and (f)) configured to charge/discharge the battery with limited charge power LIMIT CHG PWR less than the allowable maximum charge power MAX CHG PWR and limited discharge power LIMIT D/CHG PWR less than the allowable maximum discharge power MAX D/CHG PWR, as maximum values, for the standby time.

In particular, the charge/discharge profiles (refer to (c) and (d)) described above may be configured to increase charge power in stages from 0 to the allowable maximum charge power MAX CHG PWR and then decrease the charge power in stages back to 0 during half of the standby time and increase the discharge power in stages from 0 to the allowable maximum discharge power MAX D/CHG PWR and then decrease the discharge power in stages back to 0 during the other half of the standby time (refer to (c)), or maintain the allowable maximum charge power MAX CHG PWR during half of the standby time and maintain the allowable maximum discharge power MAX D/CHG PWR during the other half of the standby time (refer to (d)).

In addition, the limited charge/discharge profiles (refer to (e) and (f)) described above may be configured to increase the charge power in stages from 0 to the limited charge power LIMIT CHG PWR and then decrease the charge power in stages back to 0 during half of the standby time and increase the discharge power in stages from 0 to the limited discharge power LIMIT D/CHG PWR and decrease the discharge power in stages back to 0 during the other half of the standby time (refer to (e)), or maintain the limited charge power LIMIT CHG PWR during half of the standby time and maintain the limited discharge power LIMIT D/CHG PWR during the other half of the standby time (refer to (f)).

Specifically, when a SOC of the battery 214 is equal to or less than a preset SOC, the vehicle controller 217 may select a charge command among the control commands, and the selected charge command may be provided to the charge/discharge controller 215.

In addition, in a case in which the SOC of the battery 214 is greater than the preset SOC, if a current tariff according to the tariff information is less than a preset lower limit tariff, the vehicle controller 217 may select a charge command among the control commands, and if the current tariff according to the tariff information is greater than a preset upper limit tariff, the vehicle controller 217 may select the discharge command among the control commands, and the selected charge command or the selected discharge command may be provided to the charge/discharge controller 215. Here, the preset lower limit tariff may be, for example, a value 30% lower than an average of power costs included in the tariff information, and the preset upper limit tariff may be 30% higher than the average of the power costs included in the tariff information. It should be noted that the specific numerical values described above are provided to help the understanding of the present disclosure, and may be modified according to the needs of those skilled in the art.

Alternatively, in a case in which the SOC of the battery 214 is greater than the preset SOC, if the current tariff according to the tariff information is between the preset lower limit and the upper limit, the vehicle controller 217 may select the charge/discharge command or the limited charge/discharge command among the control commands based on a temperature of the battery 214, and the selected charge/discharge command or the limited charge/discharge command may be provided to the charge/discharge controller 215.

Specifically, when a temperature of the battery 214 is within a normal range, the vehicle controller 217 may select the charge/discharge command, among the control commands, and when the temperature of the battery 214 is out of the normal range, the vehicle controller 217 may select the limited charge/discharge command, among the control commands, and the selected charge command or the selected discharge command may be provided to the charge/discharge controller 215.

An appropriate value may be selected for the preset SOC or the normal range of temperature according to the needs of those skilled in the art, and it should be noted that specific values are not limited in the present disclosure.

In addition, according to an exemplary embodiment of the present disclosure, the vehicle controller 217 may obtain a cost according to the amount of power charged, discharged, or charged/discharged for the standby time according to the tariff information, and may be settled up later.

Finally, the charge/discharge controller 215 may charge, discharge, or charge/discharge the battery 214 according to a control command provided from the vehicle controller 217 described above. The charge/discharge controller 215 described above may be referred to as an On Board Charger (OBC).

That is, the charge/discharge controller 215 may charge the battery 214 according to the charge command provided from the vehicle controller 217, discharge the battery 214 according to the discharge command, or charge/discharge the battery 214 according to the charge/discharge command or the limited charge/discharge command.

As described above, according to an exemplary embodiment of the present disclosure, by performing test charging/discharging to charge, discharge, or charge/discharge the battery for the standby time in which calculation is performed on a charge profile, an equipment operation rate may be increased.

In addition, according to an exemplary embodiment of the present disclosure, by performing test charging/discharging with allowable maximum charge power and allowable maximum discharge power, control safety between the vehicle and the charger may be checked in advance.

In addition, according to an exemplary embodiment of the present disclosure, the user's anxiety and inconvenience may be resolved by displaying a test charging/discharging operation state during test charging and discharging, and by settling up the cost of power transaction during the test charging and discharging, a driver may be given a financial gain.

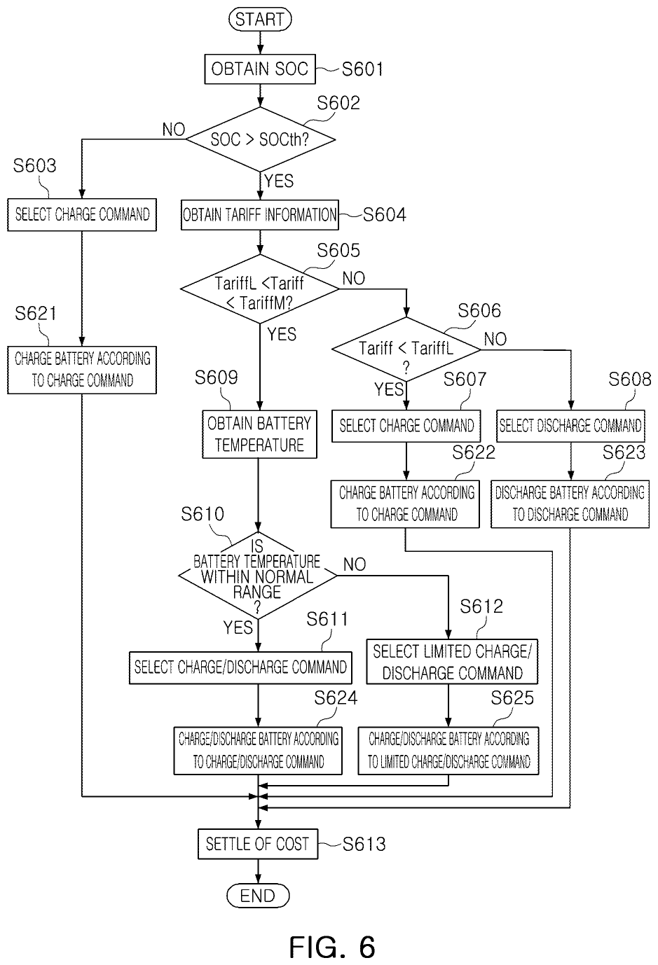

FIG. 6 is a flowchart illustrating a method for controlling test charging/discharging based on V2G technology according to an exemplary embodiment of the present disclosure. The method for controlling test charging/discharging based on V2G technology described above is based on the assumption that it is performed for a standby time for which a calculation a is performed on a charge profile.

V2G technology-based test charging/discharging control method is premised on the premise that it is performed for a standby time for which a calculation is performed on a charge profile.

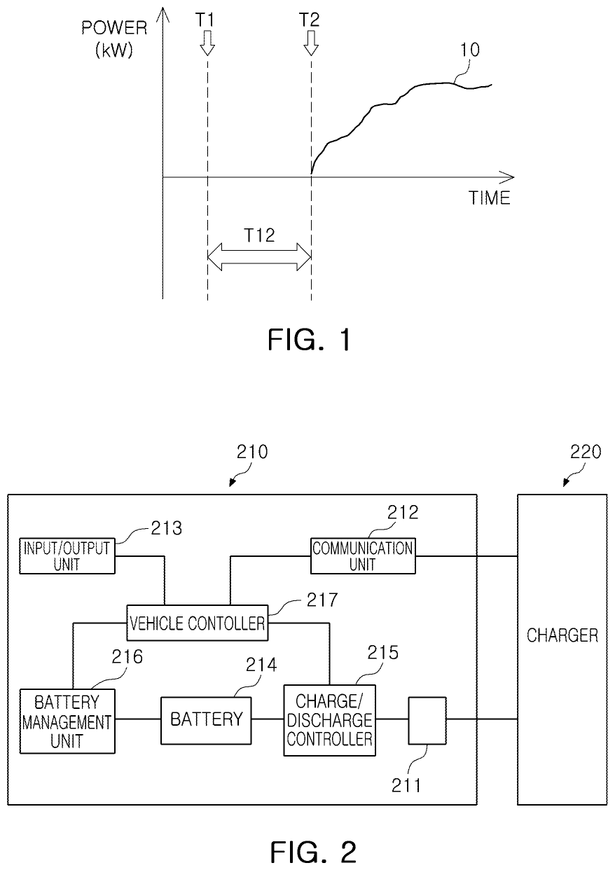

Hereinafter, the method 600 for controlling test charging/discharging based on V2G technology according to an exemplary embodiment of the present disclosure will be described with reference to FIGS. 1 to 6. However, the same descriptions as those of FIGS. 1 to 5 will be omitted for the sake of simplification of the present disclosure.

Referring to FIGS. 1 to 6, method 600 for controlling test charging/discharging based on V2G technology according to an exemplary embodiment of the present disclosure may include operations S601 to S612 of selecting a control command for charging, discharging or charging/discharging the battery 214 by the vehicle controller 217 and operations S621 to S625 of charging, discharging, or charging/discharging the battery 214 according to a selected control command by the charge/discharge controller 215.

The control commands described above may include one of a charge command including a charge profile (refer to (a) of FIG. 5) configured to charge the battery with maximum charge power MAX CHG PWR allowable for a standby time, a discharge command including a discharge profile (refer to (b) of FIG. 5) configured to discharge the battery with maximum discharge power MAX D/CHG PWR allowable for the standby time, a charge/discharge command including charge/discharge profiles (refer to (c) and (d) of FIG. 5) configured to charge and discharge the battery with the maximum charge power MAX CHG PWR and the maximum discharge power MAX D/CHG PWR allowable for the standby time as maximum values, and a limited charge/discharge command including limited charge/discharge profiles (refer to (e) and (f) of FIG. 5) configured to charge/discharge the battery with limited charge power LIMIT CHG PWR less than the maximum charge power MAX CHG PWR allowable for the standby time and limited discharge power LIMIT D/CHG PWR less than the allowable maximum discharge power MAX D/CHG PWR, as maximum values, as described above.

In particular, the charge/discharge profiles (refer to (c) and (d) of FIG. 5) described above may be configured to increase the charge power in stages from 0 to the allowable maximum charge power MAX CHG PWR and then decrease the charge power in stages back to 0 during half of the standby time and increase the discharge power in stages from 0 to the allowable maximum discharge power MAX D/CHG PWR and then decrease the discharge power in stages back to 0 during the other half of the standby time (refer to (c) of FIG. 5) or maintain the allowable maximum charge power MAX CHG PWR during half of the standby time and maintain the allowable maximum discharge power MAX D/CHG PWR during the other half of the standby time (refer to (d) of FIG. 5), as described above.

In addition, the limited charge/discharge profiles (refer to (e) and (f) of FIG. 5) described above may be configured to increase the charge power in stages from 0 to the limited charge power LIMIT CHG PWR and then decrease the charge power in stages back to 0 during half of the standby time and increase the discharge power in stages from 0 to the limited discharge power LIMIT D/CHG PWR and decrease the discharge power in stages back to 0 during the other half of the standby time (refer to (e) of FIG. 5) or maintain the limited charge power LIMIT CHG PWR during half of the standby time and maintain the limited discharge power LIMIT D/CHG PWR during the other half of the standby time (refer to (f) of FIG. 5), as described above.

First, the vehicle controller 217 may obtain an SOC of the battery 214 (S601) and determine whether the SOC of the battery 214 is greater than a preset SOC (S602).

As a result of the determination, if the SOC of the battery 214 is not greater than the preset SOC, that is, equal to or less than the preset SOC, the vehicle controller 217 may select the charge command, among the control commands (S603), and the charge/discharge controller 215 may charge the battery 214 according to the selected charge command (S621).

As a result of the determination in operation S602, if the SOC is greater than the preset SOC, the vehicle controller 217 may obtain tariff information (S604) and determine whether a current tariff according to the obtained tariff information has a value between a preset lower limit tariff TariffL and a preset upper limit tariff TariffM.

As a result of the determination, if the current tariff according to the tariff information has a value between the preset lower limit tariff TariffL and the preset upper limit tariff TariffM, the process may proceed to operation S609; otherwise, proceed to operation S606.

First, operation S606 and subsequent operations will be described.

In operation S606, the vehicle controller 217 may determine whether a current tariff according to the tariff information is less than the preset lower limit tariff TariffL (S606). As a result of the determination in S606, if the current tariff Tariff according to the tariff information is less than the preset lower limit tariff TariffL, the vehicle controller 217 may select the charge command, among the control commands (S607) and the discharge controller 215 may charge the battery 214 according to the selected charge command (S622).

Meanwhile, as a result of the determination in S606, if the current tariff Tariff according to the tariff information is not less than the preset lower limit tariff TariffL, that is, in this case, since the current tariff TariffL according to the tariff information is greater than the preset upper limit tariff TariffM, the vehicle controller 217 may select the discharge command, among the control commands (S608), and the charge/discharge controller 215 may discharge the battery 214 according to the selected discharge command (S623).

Next, operation S609 and subsequent operations will be described.

As a result of the determination in operation S605, if the current tariff Tariff according to the tariff information is between the preset lower limit tariff TariffL and the preset upper limit tariff TariffM, the vehicle controller 217 may obtain a temperature of the battery 214 (S609) and select the charge/discharge command or the limited charge/discharge command, among the control commands, based on the temperature of the battery 214 (S611 and S612).

Specifically, the vehicle controller 217 may determine whether the temperature of the battery 214 is within a normal range (S610). If it is determined in S610 that the temperature of the battery 214 is within the normal range, the vehicle controller 217 may select the charge/discharge command, among the control commands (S611), and the charge/discharge controller 215 may charge/discharge the battery 214 according to the selected charge/discharge command (S624).

Meanwhile, if it is determined in S610 that the temperature of the battery 214 is out of the normal range, the vehicle controller 217 may select the limited charge/discharge command, among the control commands (S612), and the charge/discharge controller 215 may charge/discharge the battery 214 according to the selected limited charge/discharge command (S625).

Thereafter, the vehicle controller 217 may obtain a cost according to the amount of power to be charged, discharged, or charged and discharged for the standby time according to the tariff information, and may settle up the cost later (S613).

Meanwhile, according to an exemplary embodiment of the present disclosure, the test charging/discharging operation state may be displayed for the standby time as described above.

As described above, according to an exemplary embodiment of the present disclosure, by performing a test charging/discharging to charge, discharge, or charge/discharge the battery for the standby time in which calculation is performed on a charge profile, the equipment operation rate may be increased.

In addition, according to an exemplary embodiment of the present disclosure, by performing test charging and discharging with the allowable maximum charge power and the allowable maximum discharge power, control safety between the vehicle and the charger may be checked in advance.

In addition, according to an exemplary embodiment of the present disclosure, the user's anxiety and inconvenience may be resolved by displaying the test charging/discharging operating state during test charging and discharging, and by setting up the cost of power transaction during the test charging and discharging, a driver may be given a financial gain.

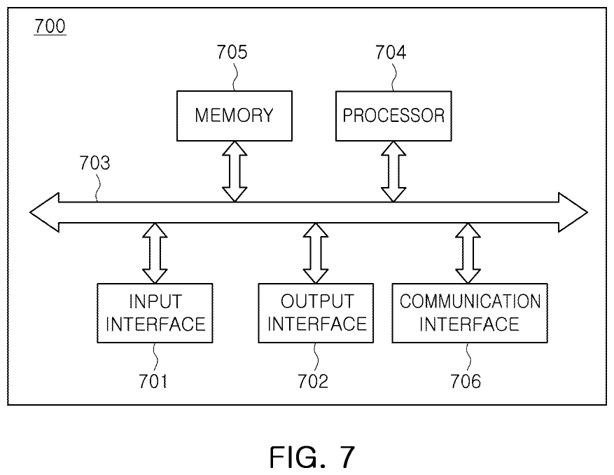

Meanwhile, FIG. 7 is a block diagram of a computer device capable of fully or partially implementing an apparatus for controlling test charging/discharging based on the V2G technology according to an exemplary embodiment of the present disclosure, which may be applied to the apparatus 210 for controlling test charging and discharging based on the V2G technology illustrated in FIG. 2.

As shown in FIG. 7, a computer device 700 may include an input interface 701, an output interface 702, a processor 704, a memory 705, and a communication interface 706. The input interface 701, the output interface 702, the processor 704, the memory 705, and the communication interface 706 may be interconnected via a system bus 703.

In an exemplary embodiment of the present disclosure, the memory 705 may be used to store a program, an instruction or code, and the processor 704 may execute the program, the instruction or code stored in the memory 705, receive a signal by controlling the input interface 701, and transmit a signal by controlling the output interface 702. The memory 705 described above may include read-only memory and random access memory, and may provide instructions and data to the processor 704. The communication interface 706 may implement the communication unit 212.

In an exemplary embodiment of the present disclosure, the processor 704 may be a central processing unit (CPU), and may be another general-purpose processor, a digital signal processor (DSP), or an application specific integrated circuit (ASIC), field programmable gate array (FPGA) or other programmable logic device, discrete gate or transistor logic device, discrete hardware component, or the like. The general-purpose processor may be a microprocessor, or the corresponding processor may be any conventional processor or the like. The processor 704 described above may perform the operation of the apparatus for controlling test charging and discharging based on V2G technology described above.

In one implementation process, the method of FIG. 6 may be achieved by an integrated logic circuit of hardware in the processor 704 or an instruction in the form of software. The contents of the method disclosed in relation to the embodiment of the present disclosure may be implemented to be performed and completed by a hardware processor or may be performed and completed by a combination of hardware and software modules of the processor. The software module may be disposed in a storage medium such as random access memory, flash memory, read-only memory, programmable read-only memory or electrically erasable programmable memory, registers, and the like. The corresponding storage medium is located in the memory 705, and the processor 704 reads information from the memory 705 and implements the contents of the method described above in combination with hardware. In order to avoid duplication, detailed descriptions thereof are omitted herein.

As set forth above, according to an exemplary embodiment of the present disclosure, by performing test charging/discharging to charge, discharge, or charge/discharge the battery for the standby time in which calculation is performed on a charge profile, an equipment operation rate may be increased.

In addition, according to an exemplary embodiment of the present disclosure, by performing test charging/discharging with allowable maximum charge power and allowable maximum discharge power, control safety between the vehicle and the charger may be checked in advance.

In addition, according to an exemplary embodiment of the present disclosure, the user's anxiety and inconvenience may be resolved by displaying a test charging/discharging operation state during test charging and discharging, and by settling up the cost of power transaction during the test charging and discharging, a driver may be given a financial gain.

While embodiments have been shown and described above, it will be apparent to those skilled in the art that modifications and variations could be made without departing from the scope of the present disclosure as defined by the appended claims.

What is claimed is:

1. An apparatus for controlling test charging and discharging based on vehicle to grid (V2G) technology, the apparatus comprising:
a vehicle controller selecting a control command for charging, discharging, or charging/discharging a battery; and
a charge/discharge controller charging, discharging, or charging/discharging the battery according to the selected control command,
wherein an operation of the vehicle controller and an operation of the charge/discharge controller are performed for a standby time in which calculation is performed on a charge profile.

2. The apparatus of claim 1, wherein the control command comprises one of:
a charge command comprising a charge profile configured to charge the battery with allowable maximum charge power for the standby time,
a discharge command comprising a discharge profile configured to discharge the battery with allowable maximum discharge power for the standby time,
a charge/discharge command comprising a charge/discharge profile configured to charge and discharge the battery with the allowable maximum charge power and the allowable maximum discharge power, as maximum values, for the standby time, and
a limited charge/discharge command comprising a limited charge/discharge profile configured to charge/discharge the battery with limited charge power less than the allowable maximum charge power and limited discharge power less than the allowable maximum discharge power, as maximum values, for the standby time.

3. The apparatus of claim 2, wherein
the vehicle controller selects the charge command among the control commands when a state of charge (SOC) of the battery is equal to or less than a preset SOC, and
the charge/discharge controller charges the battery according to the selected charge command.

4. The apparatus of claim 2, wherein,
when the SOC of the battery is greater than a preset SOC, if a current tariff according to tariff information is less than a preset lower limit tariff, the vehicle controller selects the charge command among the control commands, and if the current tariff according to the tariff information is greater than a preset upper limit tariff, the vehicle controller selects the discharge command among the control commands, and
the charge/discharge controller charges the battery according to the selected charge command or discharges the battery according to the selected discharge command.

5. The apparatus of claim 2, wherein,
when an SOC of the battery is greater than a preset SOC and the current tariff according to the tariff information is between a preset lower limit tariff and a preset upper limit tariff, the vehicle controller selects the charge/discharge command or the limited charge/discharge command, among the control commands, based on a temperature of the battery, and
the charge/discharge controller charges/discharges the battery according to the selected charge/discharge command or the selected limited charge/discharge command.

6. The apparatus of claim 5, wherein,
when a temperature of the battery is within a normal range, the vehicle controller selects the charge/discharge command among the control commands, and when the temperature of the battery is out of the normal range, the vehicle controller selects the limited charge/discharge command among the control commands, and
the charge/discharge controller charges/discharges the battery according to the selected charge/discharge command or the selected limited charge/discharge command.

7. The apparatus of claim 2, wherein
the charge/discharge profile is configured to increase charge power in stages from 0 to the allowable maximum charge power and then decrease the charge power in stages back to 0 during half of the standby time and increase discharge power in stages from 0 to the allowable maximum discharge power and then decrease the discharge power in stages back to 0 during the other half of the standby time, or
maintain the allowable maximum charge power during half of the standby time and maintain the allowable maximum discharge power during the other half of the standby time.

8. The apparatus of claim 2, wherein
the limited charge/discharge profile is configured to increase charge power in stages from 0 to limited charge power and then decrease the charge power in stages back to 0 during half of the standby time and increase discharge power in stages from 0 to the limited discharge power and decrease the discharge power in stages back to 0 during the other half of the standby time, or
maintain the limited charge power during half of the standby time and maintain the limited discharge power during the other half of the standby time.

9. The apparatus of claim 1, further comprising an input/output unit displaying a test charge/discharge operation state or an estimated charge/discharge profile until charging is terminated after completion of calculation with respect to a charge profile or for the standby time.

10. The apparatus of claim 1, wherein the vehicle controller settles up cost according to an amount of power charged, discharged, or charged/discharged for the standby time.

11. A method for controlling test charging and discharging based on vehicle to grid (V2G), the method comprising:
a first operation of selecting, by a vehicle controller, a control command for charging, discharging, or charging/discharging a battery; and
a second operation of charging, discharging, or charging/discharging the battery, by a charge/discharge controller, according to the selected control command,
wherein the first operation and the second operation are performed for a standby time in which calculation is performed on a charge profile.

12. The method of claim 11, wherein the control command comprises one of:
a charge command comprising a charge profile configured to charge the battery with allowable maximum charge power for the standby time,
a discharge command comprising a discharge profile configured to discharge the battery with allowable maximum discharge power for the standby time,
a charge/discharge command comprising a charge/discharge profile configured to charge and discharge the battery with the allowable maximum charge power and the allowable maximum discharge power, as maximum values, for the standby time, and
a limited charge/discharge command comprising a limited charge/discharge profile configured to charge/discharge the battery with limited charge power less than the allowable maximum charge power and limited discharge power less than the allowable maximum discharge power, as maximum values, for the standby time.

13. The apparatus of claim 12, wherein,
in the first operation, the charge command among the control commands is selected when a state of charge (SOC) of the battery is equal to or less than a preset SOC, and
in the second operation, the battery is charged according to the selected charge command.

14. The method of claim 12, wherein,
in the first operation, when an SOC of the battery is greater than a preset SOC, if a current tariff according to tariff information is less than a preset lower limit tariff, the charge command, among the control commands, is selected, and if the current tariff according to the tariff information is greater than a preset upper limit tariff, the discharge command, among the control commands, is selected, and
in the second operation, the battery is charged according to the selected charge command, or the battery is discharged according to the selected discharge command.

15. The method of claim 12, wherein,
in the first operation, when an SOC of the battery is greater than a preset SOC and the current tariff according to the tariff information is between a preset lower limit tariff and a preset upper limit tariff, the charge/discharge command or the limited charge/discharge command, among the control commands, is selected based on a temperature of the battery, and
in the second operation, the battery is charged/discharged according to the selected charge/discharge command or the selected limited charge/discharge command.

16. The method of claim 15, wherein,
in the first operation, when a temperature of the battery is within a normal range, the charge/discharge command, among the control commands, is selected, and when the temperature of the battery is out of the normal range, the limited charge/discharge command, among the control commands, is selected, and
in the second operation, the battery is charged/discharged according to the selected charge/discharge command or the selected limited charge/discharge command.

17. The method of claim 12, wherein the charge/discharge profile is configured to:
increase charge power in stages from 0 to the allowable maximum charge power and then decrease the charge power in stages back to 0 during half of the standby time and increase discharge power in stages from 0 to the allowable maximum discharge power and then decrease the discharge power in stages back to 0 during the other half of the standby time, or
maintain the allowable maximum charge power during half of the standby time and maintain the allowable maximum discharge power during the other half of the standby time.

18. The method of claim 12, wherein the limited charge/discharge profile is configured to:
increase charge power in stages from 0 to limited charge power and then decrease the charge power in stages back to 0 during half of the standby time and increase discharge power in stages from 0 to the limited discharge power and decrease the discharge power in stages back to 0 during the other half of the standby time, or
maintain the limited charge power during half of the standby time and maintain the limited discharge power during the other half of the standby time.

19. The method of claim 11, further comprising displaying a test charge/discharge operation state or an estimated charge/discharge profile until charging is terminated after completion of calculation with respect to a charge profile for the standby time.

20. The method of claim 11, further comprising settling up cost according to an amount of power charged, discharged or charged/discharged for the standby time.
